(19) United States
(12) Patent Application Publication
(10) Pub. No.: US 2023/0160407 A1
(43) Pub. Date: May 25, 2023

(54) FITTING

(71) Applicant: REME-Möbelbeschläge GmbH, Hövelhof (DE)

(72) Inventor: Bruno Meier, Hövelhof (DE)

(21) Appl. No.: 17/990,951

(22) Filed: Nov. 21, 2022

(30) Foreign Application Priority Data
Nov. 22, 2021 (DE) 20 2021 003 572.9

(51) Int. Cl. F16B 5/02

(52) U.S. Cl. CPC F16B 5/02

(57) ABSTRACT

A fitting, in particular a fitting for furniture, includes perforations for screwing the fitting to a component. Self-tapping screws are premounted on the fitting and inserted and retained in the perforations in such a way that screw tips of the screws protruding from the fitting can be inserted into bores of the component.

### CROSS-REFERENCE TO RELATED APPLICATION

This application claims the priority, under 35 U.S.C. § 119, of German Patent Application DE 20 2021 003 572.9, filed Nov. 22, 2021; the prior application is herewith incorporated by reference in its entirety.

### FIELD AND BACKGROUND OF THE INVENTION

The invention relates to a fitting, in particular for furniture, having perforations for screwing the fitting to a component.

Items of furniture are frequently delivered in a disassembled state to an end user who then has to finish building the item of furniture. A large number of fittings, for example guide rails for drawers or the like, are generally required to do that. Various screws, which generally have to be painstakingly picked out from a lot of small parts, are required to fasten the fittings to parts of items of furniture. It is often found in that case that there are not enough of the screws that are needed or that they are missing altogether.

### SUMMARY OF THE INVENTION

It is accordingly an object of the invention to provide a fitting, which overcomes the hereinafore-mentioned disadvantages of the heretofore-known fittings of this general type.

With the foregoing and other objects in view there is provided, in accordance with the invention, a fitting, in particular for furniture, having perforations for screwing it to a component, and self-tapping screws being inserted and retained, premounted, in the perforations in such a way that the screw tips, protruding from the fitting, can be inserted into bores of the component.

In the case of such a fitting, it is ensured initially in the factory that the correct screws are inserted into the correct perforations. The end customer no longer has to look for the correct screws. Instead, he or she can screw on the fitting directly, there being no complicated placing of screws on the fitting and furthermore precise positioning and prefixing are ensured by the protruding screw tips in corresponding bores in the component.

It is important to retain the screw in the perforation for the fitting according to the invention. In order to ensure that it is retained, it is provided that a perforation has a circular basic shape from which protrude segments or fingers which face radially inward and retain the tapping thread of a screw.

In addition to the screw being retained securely, it is also centered inside the perforation if three segments or fingers are provided with a 120° spacing.

In a further embodiment of the fitting according to the invention, it is provided that the diameter of a screw section between the head and the tapping thread corresponds to the diameter of the basic shape. This screw section can thus enter the perforation without any problems.

If it is furthermore provided that the axial length of the screw section corresponds to the material thickness of the fitting around the perforation, this screw section enters completely into the perforation and the section provided with the tapping thread protrudes completely from the fitting.

If the material thickness of the fitting is insufficient for this, it is furthermore provided that a ring, which forms a bearing surface for the underside of the screw head, protrudes from the fitting, around the perforation.

The fitting preferably takes the form of a drawer guide profile. In the case of such a fitting, a pair of perforations with premounted screws is provided at the end. It is furthermore provided that the perforations are disposed in a line in the longitudinal extent of the fitting. By virtue of these measures, such a fitting can be used in a versatile way with different items of furniture.

Such a fitting, which takes the form of a drawer guide profile, is further explained with the aid of the drawings.

Other features which are considered as characteristic for the invention are set forth in the appended claims.

Although the invention is illustrated and described herein as embodied in a fitting, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded, perspective view of the fitting;

FIG. 2 is a perspective view according to FIG. 1 with inserted screws;

FIG. 3 is an enlarged illustration of an inserted screw;

FIG. 4 is a plan view of a pair of perforations; and

FIG. 5 is a cross-sectional view through a perforation with a screw inserted.

### DETAILED DESCRIPTION OF THE INVENTION

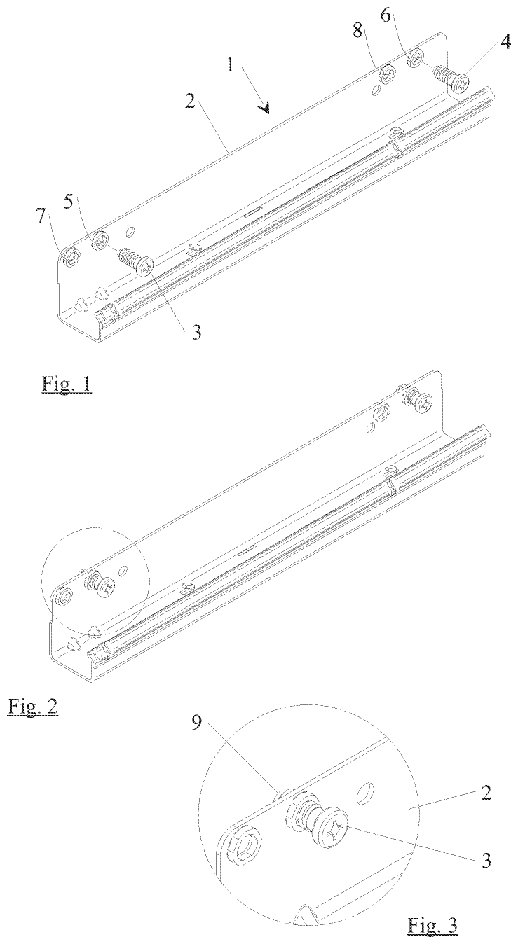

Referring now to the figures of the drawings in detail and first, particularly, to FIG. 1 thereof, there is seen a drawer guide profile which is reproduced by way of example for a fitting 1 according to the invention. A side wall 2 of the fitting 1 is to be fixed to a component (not illustrated) of an item of furniture. It is fixed with screws 3, 4 which pass through perforations 5, 6 and enter into corresponding bores of the component of the item of furniture.

In the exemplary embodiment of the fitting 1, a pair of perforations 5, 7; 6, 8 is provided at each end along a line in the longitudinal extent of the fitting 1. A wide range of fastening options for the fitting 1 is thus possible.

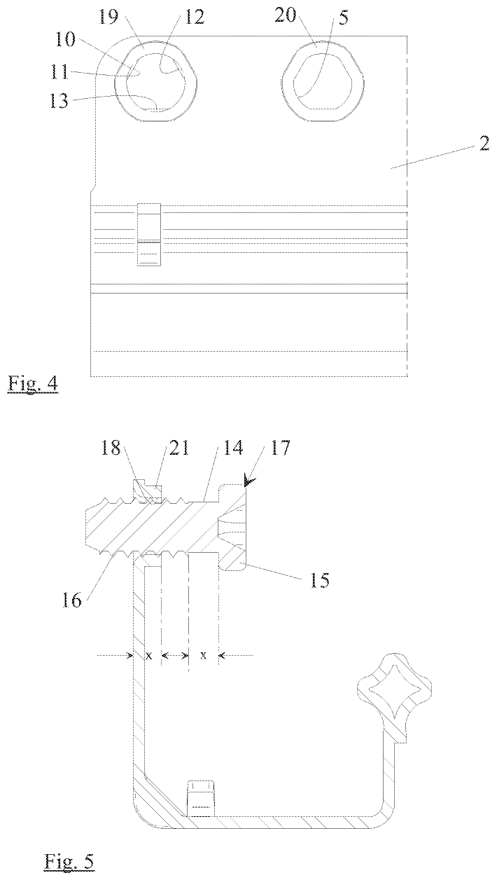

FIG. 2 shows the fitting 1 with the screws 3, 4 inserted into the perforations 5, 6. The self-tapping screws 3, 4 are premounted and inserted and retained in the perforations 5, 6 so far that screw tips 9 protrude from the longitudinal wall 2 of the fitting 1 (compare the enlarged illustration in FIG. 3).

FIG. 4 shows an enlarged plan view of the perforations 5, 7 in the longitudinal wall 2 of the fitting 1. It can readily be seen that these perforations 5, 7 have a non-round form. Although the perforation 7 has a circular basic shape 10, indicated in dashed lines, three segments 11 to 13 protrude radially inward from this basic shape 10. The diameter of the basic shape 10 corresponds to the diameter of a screw section 14 between a head 15 and a tapping thread 16 of a screw 17 reproduced in FIG. 5. The axial length x of this screw section 14 corresponds to the material thickness x in the region of a perforation 18.

This is ensured in the case of low material thicknesses, such as in the case of the side wall 2, by rings 19, 20 and 21 shown in FIG. 5, which protrude from the side wall 2 and form a bearing surface for the underside of the head 15 of the screw 17.

The following is a summary list of reference numerals and the corresponding structure used in the above description of the invention.

### LIST OF REFERENCE NUMERALS

1 fitting
2 longitudinal wall
3 screw
4 screw
5 perforation
6 perforation
7 perforation
8 perforation
9 screw tip
10 basic shape
11 segment
12 segment
13 segment
14 screw section
15 head
16 tapping thread
17 screw
18 perforation
19 ring
20 ring
21 ring

1. A fitting or furniture fitting, comprising:
perforations formed in the fitting for screwing the fitting to a component; and
self-tapping screws having screw tips;
said self-tapping screws being inserted, retained and premounted in said perforations causing said screw tips to protrude from the fitting for insertion into bores formed in the component.

2. The fitting according to claim 1, wherein one of said self-tapping screws has a tapping thread, and one of said perforations has a circular basic shape and segments or fingers protruding from said circular basic shape, facing radially inward and retaining said tapping thread.

3. The fitting according to claim 2, wherein said segments or fingers include three segments or fingers being mutually spaced apart by 120°.

4. The fitting according to claim 2, wherein said basic shape has a diameter, said self-tapping screw has a head and a screw section between said head and said tapping thread, and said screw section has a diameter corresponding to said diameter of said basic shape.

5. The fitting according to claim 4, which further comprises a material thickness of the fitting around said perforation, said screw section having an axial length corresponding to said material thickness.

6. The fitting according to claim 4, wherein said screw head has an underside, and a ring protrudes from the fitting around said perforation and forms a bearing surface for said underside of said screw head.

7. The fitting according to claim 1, wherein the fitting is a drawer guide profile having ends, said perforations include pairs of perforations, each pair being disposed at a respective one of said ends, and said self-tapping screws are each premounted in a respective one of said perforations.

8. The fitting according to claim 7, wherein said perforations are disposed along a line in a longitudinal extent of the fitting.
